(19) United States
(12) Patent Application Publication
(10) Pub. No.: US 2026/0099628 A1
(43) Pub. Date: Apr. 9, 2026

(54) DATA FILE SEGMENT OBFUSCATION AND REASSEMBLY

(71) Applicant: Microsoft Technology Licensing, LLC, Redmond, WA (US)

(72) Inventor: Samuel Robert CUNDALL, Mercer Island, WA (US)

(73) Assignee: Microsoft Technology Licensing, LLC, Redmond, WA (US)

(21) Appl. No.: 18/910,911

(22) Filed: Oct. 9, 2024

(51) Int. Cl. G06F 21/62

(52) U.S. Cl. CPC G06F 21/6254

(57) ABSTRACT

A computer-implemented method includes dividing a data file into a plurality of data segments and assigning segment identifiers to the data segments, respectively. The data segments, if combined using a first sequence of the segment identifiers, form the data file. The method also includes shuffling, according to a reordering pattern, the segment identifiers into a second sequence that is different from the first sequence. The reordering pattern indicates a mapping between the first sequence and the second sequence. The method further includes representing the reordering pattern in metadata, and providing the plurality of data segments and the metadata to an interface for an implementation of one or more networking protocols, which implements at least a transport protocol. The plurality of data segments are provided to the interface in order of the second sequence. Related systems and software are also disclosed.

### BACKGROUND

Nowadays, it is ubiquitous for users to upload and share files in a cloud environment. Secure data file transmission in such settings involves significant challenges, particularly in data obfuscation and secure uploading/sharing. Ensuring that data is obfuscated effectively during transit and storage is crucial to prevent unauthorized access and data breaches, thereby maintaining user trust. This includes using advanced encryption techniques and secure protocols to protect data integrity and confidentiality. Additionally, managing the secure upload and sharing of large files, such as videos and images, requires efficient encryption algorithms that do not compromise performance. Thus, room for improvements exists for optimizing data obfuscation methods and enhancing secure file sharing mechanisms to ensure robust protection without sacrificing efficiency.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In some aspects, the techniques described herein relate to a computer-implemented method including, with a software application, dividing a data file into a plurality of data segments and assigning segment identifiers to the data segments, respectively. The data segments, if combined using a first sequence of the segment identifiers, form the data file. The method also includes shuffling the segment identifiers into a second sequence of the segment identifiers according to a reordering pattern, and representing the reordering pattern in metadata. The second sequence is different from the first sequence. The reordering pattern indicates a mapping between the first sequence and the second sequence. The method further includes providing, to an interface for an implementation of one or more networking protocols, the plurality of data segments and the metadata. The implementation of one or more networking protocols implements at least a transport protocol. The plurality of data segments are provided to the interface in order of the second sequence.

In some aspects, the techniques described herein relate to one or more computer-readable media having stored thereon computer-executable instructions for causing a computer system, when programmed thereby, to perform operations with a software application. The operations include retrieving, metadata relating to a plurality of data segments having segment identifiers, respectively, from an interface for an implementation of one or more networking protocols. The implementation of one or more networking protocols implements at least a transport protocol. The metadata represents a reordering pattern that indicates a mapping between a first sequence of the segment identifiers and a second sequence of the segment identifiers. The second sequence is different from the first sequence. The operations also include retrieving, from the interface for the implementation of one or more networking protocols, the plurality of data segments in order of the second sequence. The operations further include constructing a data file using the plurality of data segments and the reordering pattern, including combining, using the first sequence according to the reordering pattern, the plurality of data segments into the data file.

In some aspects, the techniques described herein relate to a computer system comprising one or more processing units and memory, wherein the computer system is configured to perform operations including: dividing a first data file into a plurality of first data segments; assigning first segment identifiers to the first data segments, respectively, wherein the first data segments, if combined using a first sequence of the first segment identifiers, form the first data file; dividing a second data file into a plurality of second data segments; assigning second segment identifiers to the second data segments, respectively, wherein the second data segments, if combined using a second sequence of the second segment identifiers, form the second data file; shuffling, according to a reordering pattern, the first segment identifiers and the second segment identifiers into a reordered sequence of the first segment identifiers and the second segment identifiers, wherein the reordering pattern indicates a mapping from the first and second sequences to the reordered sequence and vice versa; representing the reordering pattern in metadata; and providing, to an interface for an implementation of one or more networking protocols, the plurality of first data segments, the plurality of second data segments, and the metadata, wherein the implementation of one or more networking protocols implements at least a transport protocol, and wherein the plurality of first data segments and the plurality of second data segments are provided to the interface in order of the reordered sequence.

The foregoing and other features and advantages of the disclosed technologies will become more apparent from the following detailed description, which proceeds with reference to the accompanying figures.

### BRIEF DESCRIPTION OF THE DRAWINGS

FIG. 1 is an overall block diagram of an example computing system configured to implement data file segment obfuscation and reassembly according to the disclosed technologies.

FIG. 2 is a flowchart illustrating an example overall method for implementing data file segment obfuscation at a client side.

FIG. 3 is a flowchart illustrating an example overall method for reassembling a data file using data file segments at a server side.

FIG. 4 is a flowchart illustrating an example overall method for obfuscating segments of two data files at a client side.

FIG. 5 is a flowchart illustrating an example overall method for reassembling two data files using segments of the two data files at a server side.

FIG. 6A depicts an example original image to be transmitted from a client to a server.

FIG. 6B depicts an example uniform segmentation of the original image of FIG. 6A.

FIG. 6C depicts uniform segments of the original image of FIG. 6A after shuffling those segments according to an example reordering pattern.

FIG. 6D depicts an example reassembled image without knowing the reordering pattern of FIG. 6C.

FIG. 6E depicts an example reassembled image according to the reordering pattern of FIG. 6C.

FIG. 7A depicts an example non-uniform segmentation of the original image of FIG. 6A.

FIG. 7B depicts non-uniform segments of the original image of FIG. 6A after shuffling those segments according to an example reordering pattern.

FIG. 7C depicts an example reassembled image according to the reordering pattern of FIG. 7B.

FIG. 8 schematically illustrates a process of obfuscating segments of two data files and then reassembling the two data files using segments of the two data files.

FIG. 9 illustrates an example of performing segment-wise obfuscation and reconstruction of one-dimensional data files according to the disclosed technologies.

FIG. 10 illustrates an example of performing segment-wise obfuscation and reconstruction of text documents according to the disclosed technologies.

FIG. 11 illustrates an example of performing segment-wise obfuscation and reconstruction of three-dimensional images according to the disclosed technologies.

FIG. 12 illustrates an example of performing segment-wise obfuscation and reconstruction of video signals according to the disclosed technologies.

FIG. 13 is a block diagram of an example computing system in which described embodiments can be implemented.

FIG. 14 is a block diagram of an example cloud computing environment that can be used in conjunction with the technologies described herein.

### DETAILED DESCRIPTION

### Overview of Secure Data Transmission

In the modern digital landscape, the practice of uploading and sharing files in cloud environments has become ubiquitous. However, this convenience introduces substantial challenges, particularly in ensuring the secure transmission of data files. One major concern is data obfuscation, a technique that involves masking and/or encrypting data to protect it from unauthorized access during transmission and storage. This process is vital for maintaining data integrity, safeguarding user privacy, and preventing potential breaches, thereby ensuring user trust in cloud services.

Effective data obfuscation involves the application of advanced encryption techniques to ensure that data remains confidential and unaltered, even if intercepted during transmission. Secure protocols like Transport Layer Security (TLS) and Secure Sockets Layer (SSL) can be used to safeguard data during transmission by providing a framework for encrypting data and verifying its integrity. Additionally, secure signing protocols, such as JSON Web Tokens (JWT) and OAuth, can be utilized to authenticate and authorize data access, adding an additional layer of security.

Another challenge in secure data transmission is the efficient management of different file types, such as audio, images, videos, text documents, and other data files. Each file type may have unique characteristics and requirements for encryption and storage. For instance, video files often require high compression rates without losing quality, while text documents may need to maintain their formatting and readability. Audio files need to preserve sound quality, while images should retain their resolution and clarity. Implementing a data obfuscation scheme that can be efficiently and effectively applied to all these different file types can be challenging. Encryption algorithms like Advanced Encryption Standard (AES) and Rivest-Shamir-Adleman (RSA) need to be versatile enough to handle these diverse requirements without compromising performance. The balance between security and efficiency is important, as users expect quick and seamless access to their files while ensuring their data is protected.

Moreover, the secure upload and sharing of data files involve more than just data encryption. It also includes the ability to efficiently manage these files within the cloud environment. This encompasses adding, editing, and removing files securely, ensuring that only authorized users have access to specific data. Effective management practices are necessary to maintain the integrity and confidentiality of data stored in the cloud.

The technologies described herein overcome many of the technical challenges described above by employing a computationally efficient method that divides data files into segments and obfuscates the data files through a scrambling process. As described more fully below, the method involves rearranging the data segments in a reordered sequence to enhance security. The reassembly of the original data files is guided by metadata, which contains a reordering pattern that specifies the sequence for reassembling the scrambled segments. The disclosed technologies can be applied to various file types. Additionally, managing data files in the cloud can be simplified, as deleting a data file can be achieved by removing the corresponding metadata, effectively rendering the scrambled segments unusable.

### Example Computing System for Data File Segment Obfuscation and Reassembly

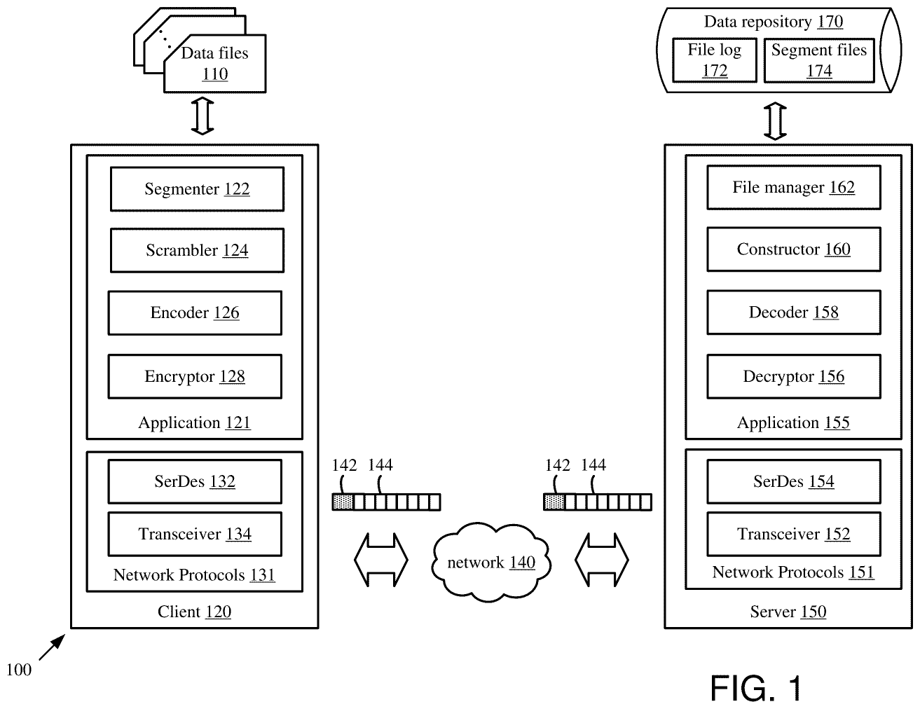

FIG. 1 shows an overall block diagram of an example computing system 100 implementing data file segment obfuscation and reassembly, according to the technologies described herein.

As shown in FIG. 1, a client 120 (also referred to as a “sender”) is connected to a server 150 (also referred to as a “data receiver”) through a network 140. The client 120 can be one of many clients and can be a computing device, such as a computer, mobile device, or the like. The client 120 can upload data files 110 to the server 150. In some examples, the server 150 is responsible for receiving, processing, and storing these data files. The server 150 can interact with the client 120 by providing necessary services, such as data encryption, storage management, and secure access controls. It should be noted that, although depicted as a server 150 in FIG. 1, the data receiver can also be simply a computing device, such as another client, or a device capable of receiving data transmitted by the client 120 and rendering a display of the original data files 110. The data files 110 transmitted from the client 120 to the server 150 can also be referred to as a payload of the data transmission.

The network 140 facilitates communication between the client 120 and the server 150. The network 140 can support various communication protocols used for secure data transmission, such as TLS, SSL, Real-Time Transport Protocol (RTP), Secure Real-Time Transport Protocol (SRTP), etc. The network connection can be wired or wireless and can utilize the Internet or other network communication channels, such as local area networks (LAN), wide area networks (WAN), cellular networks (e.g., 4G, 5G, 6G, etc.), and so on. In some examples, artificial intelligence can be employed to optimize network performance.

The client 120 can have an application 121 and an implementation of one or more networking protocols 131. In the depicted example, the application 121 includes several components, including a segmenter 122, a scrambler 124, an encoder 126, and an encryptor 128. The implementation of one or more networking protocols 131 can include a serializer and a de-serializer, collectively denoted as SerDes 132, as well as a transmitter and a receiver, collectively denoted as transceiver 134. The server 150 can also have an application 155 and an implementation of one or more networking protocols 151. As shown, the implementation of one or more networking protocols 151 can also include a transceiver 152 and a SerDes 154. The application 155 can have multiple components, including a decryptor 156, a decoder 158, a constructor 160, and a file manager 162. It should be understood that these example components are merely illustrative. For example, the client 120 and/or the server 150 can include other components. Additionally, some of the components in the client 120 and/or the server 150 can be combined or split into subcomponents to suit specific implementation needs. These components can be implemented in software, hardware, firmware, or a mixture of the same.

As described herein, the networking protocols implemented by the client 120 and the server 150 can operate across multiple layers of an Open Systems Interconnection (OSI) model, a conceptual framework that standardizes the functions of a telecommunication or computing system. The OSI model generally includes seven layers: physical, data link, network, transport, session, presentation, and application. In this context, the SerDes 132, 154 and transceivers 134, 152 can be responsible for managing the physical layer, which handles the conversion of data into signals for transmission over physical media and then reconstructs the received signals back into data. Meanwhile, the implementation of various networking protocols in the client 120 and server 150 may include transport protocols, such as Transmission Control Protocol (TCP) or User Datagram Protocol (UDP), to manage end-to-end communication and ensure reliable data transfer. Network protocols, such as Internet Protocol (IP), can manage routing and addressing at the network layer, while link layer protocols can ensure data is transferred error-free across the network's physical links. The implementations of these networking protocols 131, 151 work in tandem to ensure efficient data transmission, and the SerDes (e.g., 132, 154) and transceivers (e.g., 134, 152) can facilitate high-speed, low-latency communication by converting data between serial and parallel forms and managing the electrical signals at the hardware level.

For the application 121 on the client side, the segmenter 122 can be configured to divide a selected data file 110 into a plurality of data segments arranged in an ordered sequence, also referred to as an “original sequence” hereinafter. The segmentation process ensures that each piece of data in the data file is isolated into separate data segments, which can then be processed independently. Various methods for segmenting the data files are described more fully below.

The scrambler 124 of the application 121 takes the data segments produced by the segmenter 122 and applies a reordering pattern to shuffle these data segments into a reordered sequence that is different from the original sequence. This reordering process obscures the relationship between data segments, such that even if unauthorized users gain access to the individual data segments, they would be unable to reconstruct the original data file without knowledge of the reordering pattern. In other words, the segment obfuscation introduced by the reordering or scrambling makes the data segments individually meaningless and prevents unauthorized users from deciphering the original data file. Example methods for shuffling the data segments are described more fully below.

The encoder 126 of the application 121 can be configured to encode each data segment individually. Such encoding can include compressing the data segment to reduce its size and/or transforming it into a format suitable for data transmission. For instance, in the case of image or video data files, the encoder 126 can apply a specific compression algorithm to reduce the file size while maintaining quality (e.g., JPEG for image segments or H.264 for video segments, respectively). In some examples, the encoder 126 can be optional.

The encryptor 128 of the application 121 can be configured to encrypt metadata 142, which includes the reordering pattern of the data segments. By encrypting the metadata 142, the system ensures that the reordering pattern remains confidential and protected during subsequent data transmission. In some examples, the encryptor 128 can encrypt the metadata 142 using a public key of a recipient, such as the server 150, ensuring that only the intended recipient can decrypt and access the reordering information.

The application 121 can provide the shuffled data segments and the encrypted metadata to an interface of the implementation of one or more networking protocols 131. The SerDes 132 can be configured to serialize the data segments, now ordered in the reordered sequence, into one or more data packets 144. This serialization process can include organizing and encapsulating the data segments into a format suitable for transmission over a network (e.g., a bitstream for an image or video file).

The transceiver 134 can be configured to transmit the serialized data packets 144, along with the encrypted metadata 142, to the server 150. The transceiver 134 can follow a specific communication protocol of the network 140 to ensure that the data is sent accurately and reliably. Examples of transceivers 134 include network interface cards for Internet-based systems and modems for cellular networks.

Within the implemented network protocols 151 at the server side, the transceiver 152 can be configured to receive the serialized data packets 144 and the encrypted metadata 142 transmitted by the client 120. The transceiver 152 can handle incoming data according to the communication protocol of the network 140. The transceiver 152 can be implemented using network interface hardware or software that supports various data transmission standards.

The SerDes 154 can be configured to unpack the serialized data packets 144. For example, the SerDes 154 can extract the individual data segments from the serialized bitstream, e.g., parsing the bitstream to identify and separate each data segment, restoring them to their original, pre-serialization format.

Through an interface of the implemented network protocols 151, the application 155 can receive the encrypted metadata and the extracted data segments. Within the application 155, the decryptor 156 can be configured to decrypt the metadata 142, thereby obtaining the reordering pattern of the data segments. In some examples, the decryptor 156 can use an appropriate decryption key (e.g., a private key corresponding to the public key used by the encryptor 128) to perform the decryption.

The decoder 158 can be configured to decode each data segment according to its encoding format. Specifically, if the data segments were encoded or compressed by the encoder 126, the decoder 158 can apply necessary algorithms to reverse these transformations and restore the data segments to its original form. For instance, the decoder 158 can decompress JPEG image segments or decode H.264 video segments. In some examples, the decoder 158 can be optional.

The constructor 160 can be configured to reassemble the (decoded) data segments into their original sequence by combining or concatenating them according to the reordering pattern provided by the metadata 142 and decrypted by the decryptor 156. Specifically, the constructor 160 can align and sequence the data segments as specified by the reordering pattern to accurately reconstruct the original data file 110.

The file manager 162 can be configured to manage the storage of received data segments and metadata in a cloud-based data repository 170. Notably, the reassembled data files do not need to be saved in the data repository 170. Instead, the data segments of the original data files 110 can be saved as individual segment files 174 in the data repository 170, with each data segment stored separately. Concurrently, the reordering pattern contained in the metadata for each data file 110 can be recorded in a file log 172 within the same data repository 170. For instance, for each data file 110 transmitted from the client 120, the corresponding metadata 142, or at least the reordering pattern retrieved from the metadata 142, can be entered into the file log 172, while the data segments are stored as separate segment files 174.

In some examples, the cloud-based data repository 170 can be directly connected to the network 140 and act as an intermediary between the client 120 and the server 150. In some examples, the data repository 170 itself can have an implementation of one or more network protocols (similar to 151). For instance, the data repository 170 can be a data streaming service configured to receive the data packets 144 and metadata 142 (e.g., through its own transceiver) transmitted from the client 120, and temporarily store the received data before forwarding it to the server 150. In some examples, the data repository 170 can store (at least temporarily) the received data packets 144 or data segments included in the data packets (e.g., extracted through its own SerDes) on computer-readable media. The data repository 170 can also store the received metadata 142 or at least the reordering pattern included in the metadata 142 on the computer-readable media. In some cases, the data repository 170 can store the metadata 142 in its encrypted 142 form without decrypting it. In some cases, the data repository 170 can first decrypt the metadata 142 (e.g., the encryptor 128 can encrypt the metadata using a public key provided by the data repository 170, which can decrypt the metadata using a corresponding private key), and then save the metadata or the reordering pattern in its decrypted form on the computer-readable media. When forwarding the metadata 142 (or the reordering pattern) to the server 150, the data repository 170 can re-encrypt (e.g., through its own encryptor) the metadata 142 (or the reordering pattern), for example, by using a public key provided by the server 150.

In some cases, multiple data files 110 can be segmented and scrambled together, resulting in a mixture of data segments from various data files 110 being transmitted simultaneously to the server 150. The scrambler 124 on the client 120 can apply a combined reordering pattern across these data segments, which is then included in the encrypted metadata 142. Upon reception, the server 150 can decrypt the metadata 142 to reveal the reordering pattern, allowing the constructor 160 to reconstruct each original data file from the interleaved data segments. Additional details on obfuscating and reconstructing mixed data segments from multiple data files are described further below.

In some examples, the one or more networking protocols implemented on the client side and the server side (e.g., 131, 151) can include implementation of certain scrambling and descrambling techniques for enhancing data security during transmission. These techniques may involve scrambling data packets on the client side, thus obfuscating the original sequence of the transmitted data. On the server side, descrambling techniques can be applied to reconstruct the original sequence of the data packets. However, it is important to note that these scrambling and descrambling techniques are separate and independent of the data file segmentation and reconstruction techniques disclosed herein, which are implemented in respective applications (e.g., 121, 155) residing outside the implementations of those networking protocols. The distinction ensures that network-level security measures function independently from application-level data file segmentation and reconstruction processes.

In practice, the systems shown herein, such as the computing system 100, can vary in complexity, with additional functionality, more complex components, and the like. For example, there can be additional functionality within the server 150. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The computing system 100 and any of the other systems described herein can be implemented in conjunction with any of the hardware components described herein, such as the computing systems described below (e.g., processing units, memory, and the like). In any of the examples herein, data files, data segments, metadata, data packets, and the like can be stored in one or more computer-readable storage media or computer-readable storage devices. The technologies described herein can be generic to the specifics of operating systems or hardware and can be applied in any variety of environments to take advantage of the described features.

### Example Segmentation Methods

As described above, the segmenter 122 can divide a selected data file 110 into a plurality of data segments. The divided data segments can be non-overlapping, ensuring that each piece of data is only included in one data segment. Various segmentation methods can be used by the segmenter 122.

The segmenter 122 is configured to work with different file types, tailoring the segmentation process to suit the specific characteristics of each type. For instance, an image file can be divided into sub-images, each representing a portion of the original image. A text file can be segmented into individual paragraphs, sentences, groups of one or more tokens, or similar units. A time-series data file (e.g., an audio file, a series of sensor readings, etc.) can be divided into time intervals or segments of data samples. A video file can be segmented into individual frames or groups of frames. A database table can be divided into rows or columns.

The segmenter 122 can assign each data segment a unique identifier (also referred to as “segment identifier”). In some examples, each unique identifier can be a numerical value (e.g., an integer, a floating-point number, etc.), an alphabetical value, or a string. In some examples, each unique identifier can be a set of coordinate values that represent the segment's position within the original data file. In some examples, each unique identifier can be a hash string generated from respective content of the data segment.

The segmentation can be performed according to a specific or predefined segmentation sequence, which can also be referred to as a “scanning sequence.” For instance, in a text document or one-dimensional signal, the segmentation sequence can follow the order from start to end or in reverse. For an image file, the segmentation sequence can involve scanning from the top-left corner to the bottom-right corner (or in reverse order), either row by row, column by column, or using other scanning patterns.

After segmentation, the data segments can be ordered in the original sequence, which can be represented as a vector containing a series of unique identifiers for each data segment. The indices of this vector correspond to the positions of the data segments in the original data file. The segmentation sequence directly determines the arrangement of the data segments in the original sequence, as the order in which the data segments are created during scanning is reflected in their positions or indices within the vector.

The segmenter 122 can use various segmentation algorithms to partition data files 110. In some cases, the data segments may have uniform sizes. For instance, a simple fixed-size segmentation algorithm can be used to divide a data file into equal-sized chunks. In one specific example, the segmenter 122 can divide an image file into equal-sized image segments, such as a grid of uniformly sized blocks, each representing a specific portion of the image. In other instances, the data segments may vary in size. For example, a text file could be segmented into paragraphs of varying lengths, where each paragraph forms a distinct segment based on natural breaks in the content, rather than uniform size. In some examples, an algorithm can be employed to analyze content of the data file to determine optimal segment boundaries. In some examples, the data segments may vary not only in size but also in shape. For instance, segmenting an image file can involve dividing it into a plurality of irregularly shaped image segments, analogous to breaking the image into jigsaw puzzle pieces, where each image segment represents a distinct portion of the image.

If the data segments have different sizes, the segmenter 122 can be configured to obtain the size of each data segment and associate the size with the data segment's unique identifier. Additionally, if the data segments have various shapes, such as non-rectangular or irregularly shaped portions of an image, the shape information characterizing the boundaries of each data segment can also be obtained and associated with the corresponding identifier of the data segment. For instance, the shape information of an image segment could be represented by a set of vertices or boundary descriptors that define the contours of the image segment.

In some examples, for data segments having varying sizes and/or shapes, the segmenter 122 can also obtain the coordinates of each data segment and associate those coordinates with the data segment's unique identifier. For one-dimensional data files, such as a text document or an audio file, the coordinates can be represented as an offset relative to a reference point, like the start or end of the data file. This offset defines the position of the data segment within the overall file. For image files, the coordinates can be multidimensional values. For instance, the segmenter 122 may capture the offsets (e.g., x-y coordinates) of the top-left corner of each image segment relative to a reference point (e.g., the top-left or bottom-right corner of the image file), or it may record the coordinates of multiple corners (e.g., all four corners in the case of rectangular segments) to precisely define the segment's boundaries. Such coordinate information can be used to uniquely define the position of the image segments in the original image file.

The reordering pattern in the metadata 142 may include any combination of size, shape, and coordinate information of the data segments. This metadata 142 is then encrypted by the encryptor 128 and transmitted along with the data packets 144, which contain the encoded data segments, to the server 150. Upon receipt, the decryptor 156 at the server 150 can decrypt the metadata to reveal the reordering pattern of the data segments. The constructor 160 can then use this reordering pattern to accurately reassemble the original data file.

### Example Shuffling Methods

As described above, the scrambler 124 is configured to shuffle the data segments generated by the segmenter 122, effectively transforming the original sequence into a reordered sequence. Both the original and reordered sequences can be represented as vectors containing a series of unique identifiers for each data segment. In the reordered sequence, the order of data segments is different from that of the original sequence, meaning a data segment may occupy a different index in the vector of the reordered sequence compared to its index in the original sequence.

This shuffling can be defined by a reordering pattern which maps between the original sequence and the reordered sequence, specifying how each data segment's position in the original sequence corresponds to a new position in the reordered sequence. As described herein, the mapping indicated by the reordering pattern is invertible (that is, bidirectional), allowing each data segment in the reordered sequence to be mapped back to its original position, thereby enabling the reconstruction of the original sequence when the data file is later reassembled.

Different shuffling methods can be employed by the scrambler 124. In some examples, the scrambler 124 can be configured to perform random shuffling, where the positions of the data segments are rearranged in a random manner. As described above, the original sequence can be represented as a vector containing a series of unique identifiers corresponding to the data segments, where each identifier is associated with a specific position in the original sequence. The scrambler 124 randomly permutate the positions or indexes of those identifiers in the vector, resulting in the reordered sequence. In other words, the data segments are reordered based on this new permutation.

To achieve random shuffling, the scrambler 124 can use a random number generator to determine the new position for each data segment. In some examples, the random number generator can be seeded with a specific value, known as a random seed, to ensure the shuffling process is reproducible. In other examples, the random number generator can rely on environmental sources of entropy, such as system clock variations or hardware noise, to produce random numbers without requiring a specific seed.

In some examples, the scrambler 124 can use a pseudo-random number generator to determine the new position for each data segment. An example pseudo-random number generator is nonlinear shift register encoder. In this approach, the positions of the data segments are shifted according to a nonlinear function that depends on the current state of the shift register. The nonlinear shift register encoder can take various forms, such as a feedback shift register where the feedback function is a nonlinear combination of the register's bits. For instance, the scrambler 124 can implement a maximum length sequence generator, which produces a pseudorandom sequence of bits used to determine the positions of the data segments in the reordered sequence.

In some cases, the scrambler 124 can employ other pseudo-random or nonrandom shuffling methods, where a deterministic function can be used to generate the reordered sequence. Unlike purely random shuffling, this approach uses a mathematical function that maps the original sequence to the reordered sequence in a predictable manner. The function itself, however, can be chosen at random from a large set (e.g., thousands) of predefined functions. For example, one function can be a modular arithmetic function, where each data segment's new position is determined by applying a modulo operation to its original position. Another example function can be a hash function, where the hash value of each data segment's unique identifier can be converted into a numerical index (e.g., by taking the ASCII values of characters in the hash string and summing them, or by using a hash function that outputs a fixed-size numeric value, or by other means) that determines its position in the reordered sequence.

### Example Metadata

As described above, the metadata 142 includes the reordering pattern (i.e., the mapping that specifies how each data segment's position in the original sequence corresponds to its new position in the reordered sequence and vice versa). This metadata 142 ensures that, upon receiving the data segments, the server 150 can accurately reconstruct the original data file based on the reordering pattern.

In some examples, the metadata 142 may include both the original sequence and the reordered sequence, each represented as a list of unique identifiers of the data segments, but arranged in different orders. This allows for a straightforward comparison between the two sequences to determine the reordering pattern. Alternatively, if the unique identifiers are already arranged sequentially (e.g., in an ascending or descending order) in the original sequence, the metadata 142 may only need to include the positions of the data segments in the reordered sequence. In some examples, the metadata 142 may include a seed value for a random number generator used by the scrambler 124 to generate the reordered sequence. The decryptor 156 of the server 150 can then use the same seed value and random number generator (and any necessary parameters such as the number of data segments) to recreate the permutation of unique identifiers, thereby reconstructing the reordering pattern.

As described above, segmentation of a data file can be performed according to a specific or predefined segmentation sequence. In some examples, such segmentation sequence information can be part of the reordering pattern included in the metadata 142. The segmentation sequence information specifies the scanning order in which the data segments were created. For instance, if a text document was segmented following a top-to-bottom or start-to-end sequence, this information can be captured in the metadata 142. Similarly, for an image file, the metadata 142 can record the scanning pattern used, such as row-by-row or column-by-column from the top-left to the bottom-right corner (or the reverse order). Including this segmentation sequence information in the metadata 142 can help the server 150 to understand how the data segments were originally organized, which aids in the correct reassembly of the data file by the constructor 160.

In some examples, the reordering pattern can also include additional information of the sizes of the data segments, if the data segments have non-uniform sizes. In some examples, additional position information of the data segments, e.g., coordinates of the image segments, can be included in the reordering pattern. In some examples, if the data segments have irregular shapes, such as non-rectangular portions in image files, the reordering pattern can further include shape descriptors or boundary coordinates that define the geometry of each data segment. This information allows the constructor 160 of the server 150 to accurately reassemble the data file by using one or more of these metrics—size, coordinates, or shape—depending on the specific type of data being reconstructed. For instance, for a text file where data segments have different sizes, the constructor 160 can reassemble the document by determining the length of each text segment and placing them in sequence based on their size. As another example, for an image file where image segments have different sizes and shapes, the coordinates of each image segment can be used by the constructor 160 to position them accurately on a grid, ensuring that each image segment aligns correctly with its neighboring image segments to form the complete image.

In some examples, other types of information can also be included in the metadata 142 to enhance the data management process. For instance, checksums or hash values can be included for each data segment to enable integrity verification, ensuring that the data segments have not been altered or corrupted during transmission over the network 140. Timestamps may also be included to synchronize data segments or track the timing of their creation and modification. Additional information that can be included in the metadata 142 includes, but is not limited to, data length to specify the size of each data segment, data type to indicate the format of the data file, compression information to detail the compression algorithm used, encryption information for the decryption process, etc.

### Example Reassembly of Data Files

As described above, the constructor 160 of the server 150 can reconstruct the original data files from the received data segments. After the data segments are decoded by the decoder 158 and the metadata 142 is decrypted by the decryptor 156, the constructor 160 can use this information to reassemble the data files. The decrypted metadata 142 includes the reordering pattern, which maps each data segment's position in the reordered sequence back to its original position. By applying this reordering pattern, the constructor 160 can correctly sequence the decoded data segments in the original order.

In some cases, additional information such as segmentation sequence, segment sizes, segment coordinates, and segment shapes, which can also be included in the reordering pattern, can further aid the reassembly process. For example, consider a text document segmented into fixed-size chunks, where each segment is 1 KB in size. If the reordering pattern specifies a segmentation sequence that orders these data segments from the end of the file to the beginning, the constructor 160 will arrange the data segments in the same end-to-beginning order. In another example, consider an image file segmented into rectangular image segments or tiles of varying sizes. If the reordering pattern includes the coordinates of the top-left corner for each tile, the constructor 160 can accurately place each tile within the larger image based on these coordinates.

### Example File Management

As described above, the file manager 162 of the server 150 can store individual data segments received from the client 120 as separate segment files 174 on the data repository 170. The reordering pattern contained in metadata 142 of the corresponding data files can be stored in the file log 172. As described herein, the reordering pattern that is useful for reconstructing a data file can also be referred to as a metadata record associated with the data file. Notably, the reconstructed data files (e.g., data files reassembled by the constructor 160) do not need to be saved in the data repository 170.

By decoupling the storage of metadata records and data segments, the file manager 162 allows for greater flexibility and efficiency in managing large volumes of data files. For instance, when a reassembled data file is no longer needed, the file manager 162 can simply remove the associated metadata record from the file log 172 without deleting the individual data segments corresponding to the data file. As a result, file removal operations become much faster and less resource-intensive because only the metadata records in the file log 172 need to be updated, rather than reorganizing or deleting corresponding segment files 174.

Additionally, separating the metadata records from the data segments can enhance data deduplication and redundancy management. When individual data segments are stored separately, identical data segments from different data files may be reused, reducing the overall amount of data stored. The metadata records can track which data segments belong to which data files, allowing multiple reconstructed data files to reference the same underlying data segment. This can reduce data duplication and lead to improved storage savings, especially in environments where large volumes of similar or repeated data are processed.

### Example Overall Method for Obfuscating Segments of a Data File

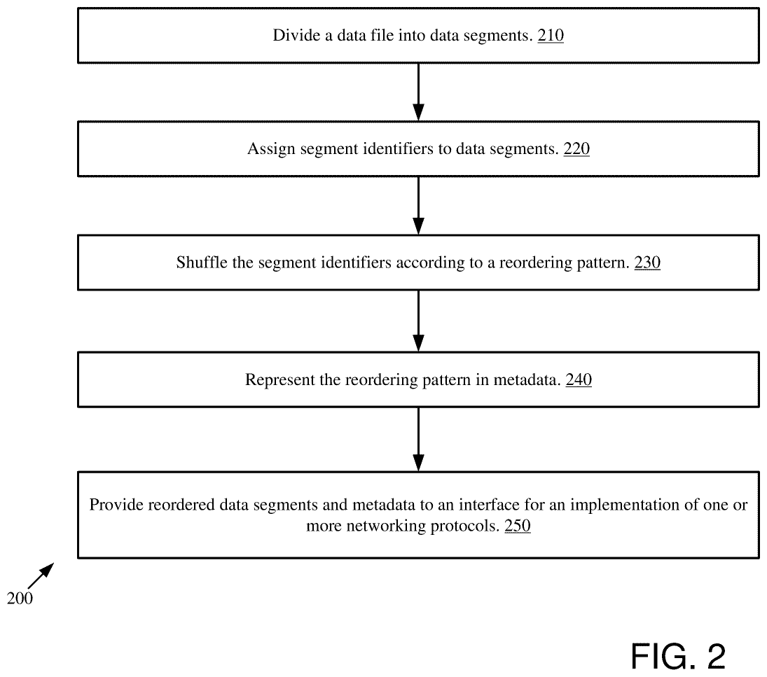

FIG. 2 is a flowchart illustrating an example overall method 200 for obfuscating segments of a data file, according to the disclosed technologies. The method 200 can be performed, e.g., by the application 121 of FIG. 1.

At step 210, the method 200 can divide a data file into a plurality of data segments. Segmentation of the data file can be performed, e.g., by the segmenter 122 of FIG. 1.

The data file can be of various file types, including but not limited to image files or data files containing 2D/3D images (e.g., JPEG, PNG, STL, GLB, OBJ, FBX, COLLADA, WebGL, WebGPU, dotLottie, SVG, JSON, etc.), video files (e.g., MP4, AVI, MOV, WebM, WMV, etc.), audio files (e.g., MP3, WAV, AIFF, AAC, WMA, PCM, etc.), text documents (e.g., TXT, DOCX, etc.), data tables or spreadsheets (e.g., CSV, XLSX, etc.), as well as more specialized formats like PDFs, archives (e.g., ZIP), and database files.

In some examples, the generated data segments can have a uniform size. In other cases, the plurality of data segments may vary in size, with some data segments being larger or smaller than others, depending on the data type and segmentation method used. In some examples, the segmentation process can follow specific segmentation sequences, such as segmenting a text document from start to end or in reverse order, or segmenting an image file row-wise or column-wise, etc. In some examples, the data segments may have irregular shapes, such as non-rectangular portions in image files.

At step 220, the method 200 can assign segment identifiers to the data segments, respectively. The data segments, if combined using a first sequence (which can also be referred to as an “original sequence”) of the segment identifiers, form the data file.

The segment identifier of each data segment can be unique. The segment identifiers can have different data types, including but not limited to numerical values, alphabetical values, string values, and coordinate values.

At step 230, the method 200 can shuffle, according to a reordering pattern, the segment identifiers into a second sequence of the segment identifiers. The second sequence (which can also be referred to as a “reordered sequence”) is different from the original sequence. The reordering pattern indicates a mapping between the original sequence and the reordered sequence. The shuffling operation can be performed, e.g., by the scrambler 124 of FIG. 1.

Various shuffling methods can be employed to transform the original sequence into the reordered sequence based on the reordering pattern. In some examples, the reordered sequence represents a random or pseudo-random permutation of the original sequence, as described above.

At step 240, the method 200 can represent the reordering pattern in metadata (e.g., the metadata 142).

The reordering pattern can indicate a mapping between each data segment's position in the original sequence and its new position in the reordered sequence. In some examples, the metadata may include a series of unique segment identifiers corresponding to each data segment, with their positions in both sequences explicitly listed. Alternatively, the metadata might contain a seed value used by the scrambler 124 to generate the reordered sequence, ensuring that the server 150 can replicate the same permutation of segment identifiers when reconstructing the sequence. Additionally, the metadata can include other relevant information, such as the segmentation sequence, segment sizes, coordinates, and shapes, which may be part of the reordering pattern.

In some examples, representing the reordering pattern in metadata includes encrypting the reordering pattern, e.g., using the encryptor 128. In one example, the encryption can be implemented by using a public key provided by a data receiver (e.g., the server 150). Other encryption techniques can also be employed to encrypt the metadata.

At step 250, the method 200 can provide, to an interface for an implementation of one or more networking protocols (e.g., 131 of FIG. 1), the plurality of data segments and the metadata. The implementation of one or more networking protocols implements at least a transport protocol. The implementation of networking protocol(s) can also implement a network protocol or network and link protocols. In contrast, an application such as the application 121 typically implements an application-layer protocol. The plurality of data segments are provided to the interface in order of the second sequence. In some examples, the data segments can be individually encoded (e.g., by the encoder 126) before being provided to the interface.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices). In some examples, the method 200 and any of the other methods described herein can be implemented and incorporated in some existing software (e.g., BabylonJS, Rive, Lottie, PhotoShop, After Affects, Figma, etc.).

The illustrated actions can be described from alternative perspectives while still implementing the technologies. For example, “send” can also be described as “receive” from a different perspective.

### Example Overall Method for Reassembling a Data File

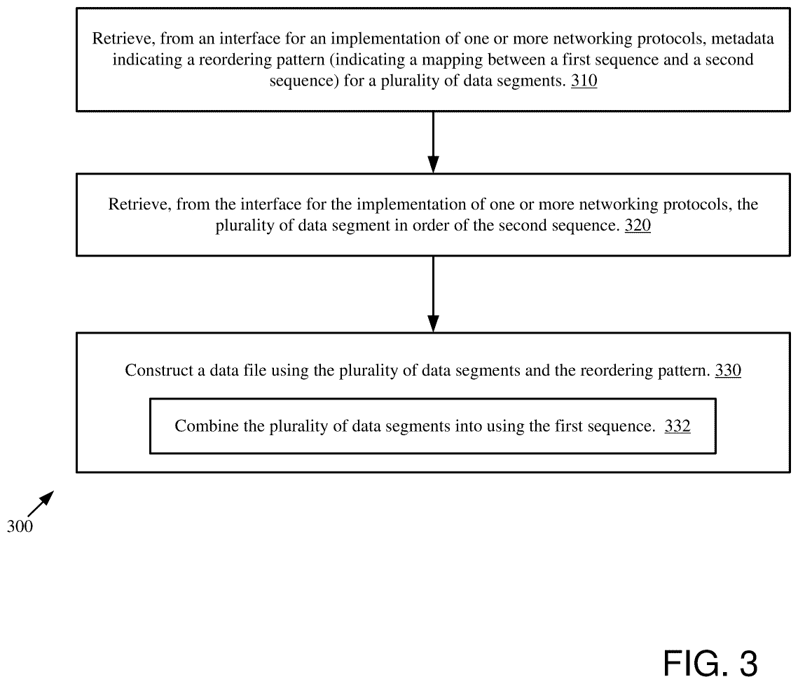

FIG. 3 is a flowchart illustrating an example overall method 300 for reassembling a data file. The method 300 can be performed, e.g., by the application 155 of FIG. 1.

In some examples, the method 300 can be performed in conjunction with the method 200 of FIG. 2, by retrieving the data segments and metadata transmitted from a client and reconstructing the original data file. In some examples, the method 300 can be performed independently by the server 150, by retrieving metadata of a data file and corresponding data segments from a data repository.

At step 310, the method 300 can retrieve, from an interface for an implementation of one or more networking protocols (e.g., 151), metadata relating to a plurality of data segments having segment identifiers, respectively. The implementation of one or more networking protocols implements at least a transport protocol. The implementation of networking protocol(s) can also implement a network protocol or network and link protocols. In contrast, an application such as the application 155 typically implements an application-layer protocol. The metadata represents a reordering pattern that indicates a mapping between a first sequence (also referred to as “original sequence”) of the segment identifiers and a second sequence (also referred to as “reordered sequence”) of the segment identifiers. The reordered sequence is different from the original sequence.

At step 320, the method 300 can retrieve, from the interface for the implementation of one or more networking protocols, the plurality of data segments in order of the reordered sequence.

As described herein, the data segments can have a uniform size or multiple non-uniform sizes.

In some examples, the plurality of data segments can be transmitted from a client. For instance, the transceiver 152 can receive serialized data packets, which can be unpacked by the SerDes 154 to extract the individual data segments, which are then provided to the application 155. If the data segments were individually encoded by the encoder 126, they can be individually decoded by the decoder 158. As described above, the data segments transmitted via those data packets can be ordered in the reordered sequence.

As described above, the reordering pattern included in the metadata can indicate a bidirectional mapping between each data segment's position in the original sequence and its new position in the reordered sequence. In some examples, the metadata transmitted by the client can be encrypted. In such circumstances, the transceiver 152 can receive the encrypted metadata, which can be provided to the application 155 where it is decrypted by the decryptor 156 (e.g., by using a private key of the server 150).

In some examples, instead of receiving the data segments and metadata transmitted directly from a client, those data segments and metadata can be retrieved from a data repository. For instance, the method 300 can retrieve metadata or metadata records indicating the reordering pattern from the file log 172. Based on the unique identifiers of the data segments specified in the reordering pattern, the corresponding data segments can be located and retrieved from the segment files 174 stored in the data repository 170.

At step 330, the method 300 can construct a data file using the plurality of data segments and the reordering pattern. As described above, the data file can be an image, a video sequence, an audio sequence, a text document, or have other file types. Constructing the data file can be performed by the constructor 160. Specifically, at step 332, the method 300 can combine or concatenate, using the original sequence according to the reordering pattern, the plurality of data segments into the data file.

If the data file is assembled based on data segments transmitted from a client, the method 300 can further save the data file in a cloud-based data repository. Instead of physically storing the data file in one large piece, the data segments can be stored as individual files (e.g., segment files 174) within the cloud-based data repository. Metadata related to the reordering pattern, or metadata record, can be recorded in a file log (e.g., file log 172) within the same data repository. When the data file is no longer needed, the method 300 can delete the data file by removing the metadata or metadata record from the file log.

### Example Overall Method for Obfuscating Segments of Multiple Data Files

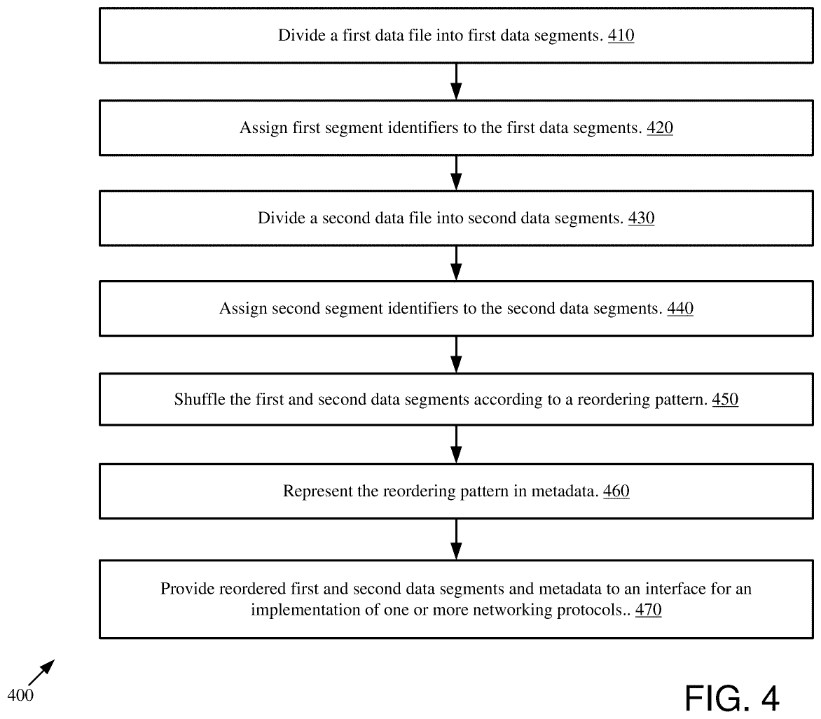

FIG. 4 is a flowchart illustrating an example overall method 400 for obfuscating segments of multiple data files. The method 400 can be performed, e.g., by the application 121 of FIG. 1.

At step 410, the method 400 can divide a first data file into a plurality of first data segments. This step is similar to step 210 in FIG. 2, where segmentation is performed for a single data file.

At step 420, the method 400 can assign first segment identifiers to the first data segments, respectively (similar to step 220 in FIG. 2). The first data segments, if combined using a first sequence (also referred to as “first original sequence”) of the first segment identifiers, form the first data file.

At step 430, the method 400 can similarly divide a second data file into a plurality of second data segments.

At step 440, the method 400 can assign second segment identifiers to the second data segments, respectively. The second data segments, if combined using a second sequence (also referred to as “second original sequence”) of the second segment identifiers, form the second data file.

At step 450, the method 400 can shuffle, according to a reordering pattern, the first segment identifiers and the second segment identifiers into a reordered sequence of the first segment identifiers and the second segment identifiers. The reordering pattern indicates a mapping from the first and second sequences to the reordered sequence and vice versa.

This step is analogous to step 230 of FIG. 2, but the reordering pattern in this case is different from the previous example as it maps data segments from both the first and second original sequences to their new positions in a single, combined reordered sequence. The reordering pattern indicates how each segment from the first and second original sequences should be positioned in the combined reordered sequence. For example, if the first original sequence is represented by a first vector of segment identifiers [A1, A2, A3] and the second original sequence is represented by a second vector of segment identifiers [B1, B2, B3], the reordering sequence might specify a new vector such as [B2, A1, B1, A3, B3, A2], in which the segment identifiers of both the first and second vectors can be combined and reordered.

The reordering pattern can provide a mapping that translates the positions or indices of the data segments in the first and second vectors into their new positions or indices within this newly combined vector.

At step 460, the method 400 can represent the reordering pattern in metadata, analogous to step 240 in FIG. 2. Similarly, the metadata can be encrypted.

At step 470, the method 400 can provide, to an interface for an implementation of one or more networking protocols (e.g., 131 of FIG. 1), the plurality of first data segments, the plurality of second data segments, and the metadata. The implementation of one or more networking protocols implements at least a transport protocol. The implementation of networking protocol(s) can also implement a network protocol or network and link protocols. In contrast, an application such as the application 121 typically implements an application-layer protocol. The plurality of first data segments and the plurality of second data segments are provided to the interface in order of the reordered sequence. This step is similar to step 250 in FIG. 2, except that both the plurality of first data segments and the plurality of second data segments are shuffled together and then provided to the interface.

Although the method 400 describes handling two data files, it is equally applicable to scenarios involving more than two data files. The same principles of segmentation, shuffling, and metadata representation can be extended to manage multiple data files simultaneously, with the reordering pattern adapting to incorporate data segments from all involved data files into a unified reordered sequence.

### Example Overall Method for Reassembling Multiple Data Files

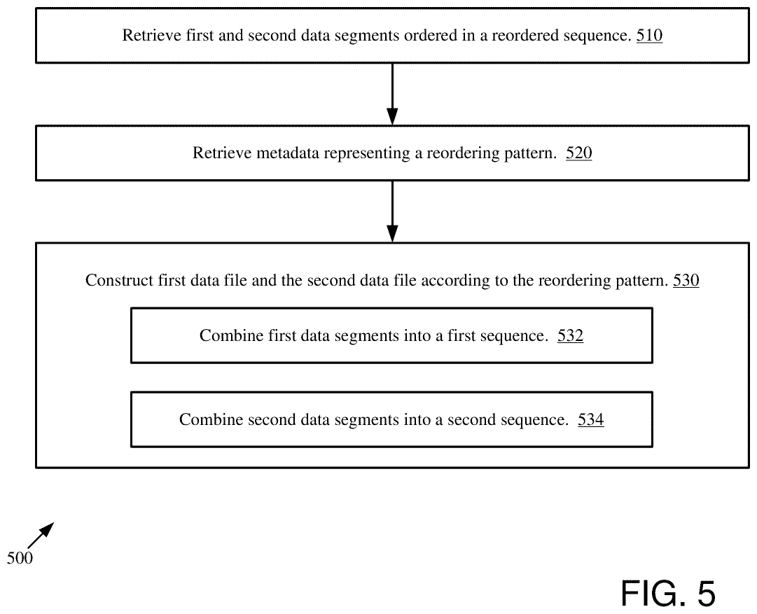

FIG. 5 is a flowchart illustrating an example overall method 500 for reassembling multiple data files. The method 500 can be performed, e.g., by the application 155 of FIG. 1.

In some examples, the method 500 can be performed in conjunction with the method 400 of FIG. 4, by retrieving the data segments and metadata originally transmitted from a client and reconstructing the multiple original data files. In some examples, the method 500 can be performed independently by the server 150, by retrieving metadata of a data file and corresponding data segments from a data repository.

At step 510, the method 500 can retrieve a plurality of data segments, which can include a plurality of first data segments (of a first data file) and a plurality of second data segments (of a second data file) ordered in a reordered sequence. This retrieval step can be similar to steps 310 and 320 in FIG. 3, but accommodating first and second data segments from two separate data files.

At step 520, the method 500 can retrieve metadata representing a reordering pattern, analogous to step 320 in FIG. 3. The reordering pattern indicates how data segments from each of the two data files are positioned in the reordered sequence, as described above.

At step 530, the method 500 can construct the first data file and the second data file, similar to step 330 in FIG. 3, adapting to concurrent reassembly of two data files. For example, at step 532, the first data file can be assembled by combining or concatenating, according to the reordering pattern, the plurality of first data segments (e.g., into the first original sequence). Likewise, at step 534, the second data file can be assembled by combining or concatenating, according to the reordering pattern, the plurality of second data segments (e.g., into the second original sequence).

Although the method 500 illustrates reassembling two data files, it can be extended to reassemble more than two data files concurrently. The same approach applies to multiple data files, with the reordering pattern mapping data segments from all involved data files to their respective positions in the reconstructed data files.

### Example Obfuscation and Reassembly of Uniform Image Segments

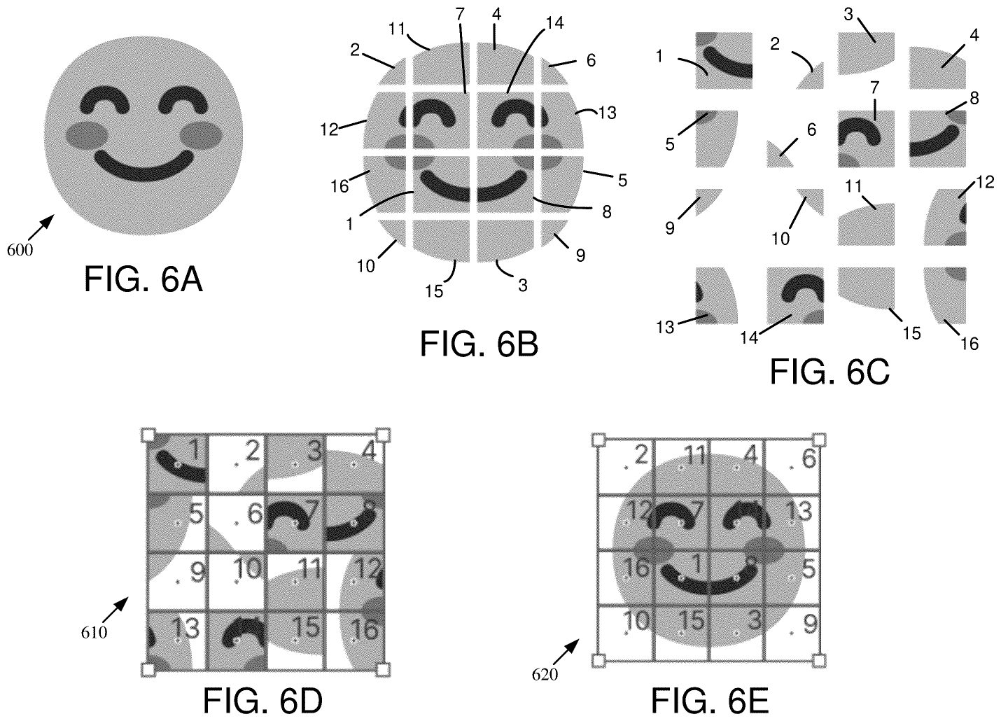

FIGS. 6A-6E illustrate an example use case of obfuscating and reassembling an image file using the techniques described herein.

FIG. 6A shows an original image 600 that a client intends to transmit to a sever.

FIG. 6B demonstrates the segmentation of the original image 600 of FIG. 6A. In this example, the size of the image segments is uniform. In this example, the image 600 is divided into 16 uniform segments, though the image 600 could alternatively be divided into more or fewer segments (e.g., more rows, more columns, fewer rows, or few columns) depending on the application.

Each image segment is assigned a unique segment identifier. For simplicity, the identifiers are 1-16 in this example, but they can also be different as long as they can uniquely identify the image segments.

The image segments are initially arranged in an original sequence, which can be represented by a vector containing the unique identifiers of each segment. The arrangement of these segments in the original sequence depends on the segmentation sequence or the chosen scanning pattern. For instance, a row-by-row scanning sequence from top-left to bottom-right might yield a vector such as [2, 11, 4, 6, 12, 7, 14, 13, 16, 1, 8, 5, 10, 15, 3, 9]. Alternatively, the original sequence could follow different patterns, such as scanning column-by-column from top-left to bottom-right, which might produce a vector like [2, 12, 16, 10, 11, 7, 1, 15, 4, 14, 8, 3, 6, 13, 5, 9]. Similarly, a bottom-right to top-left row-by-row scanning pattern would result in a different original sequence vector [9, 3, 15, 10, 5, 8, 1, 16, 13, 14, 7, 12, 6, 4, 11, 2]. Other scanning patterns such as zigzag scanning can also be employed and will result in different original sequences.

In FIG. 6C, the image segments are shown in a scrambled, reordered sequence after being shuffled. This shuffling can be random or pseudo-random, as discussed previously. A reordering pattern dictates how the original sequence is transformed into the reordered sequence. The reordering pattern will map the original sequence to a reordered sequence, which can be represented by a vector [1, 2, 3, 4, 5, 6, 7, 8, 9, 10, 11, 12, 13, 14, 15, 16], following the top-left to bottom-right, row-wise scan. Alternatively, the reordering sequence can be represented by different vectors depending on the scanning sequence.

As described above, the reordering pattern can be part of metadata that is encrypted. The image segments can be individually encoded and then provided, in the reordered sequence, to an interface for an implementation of one or more networking protocols (e.g., 131). Then, the image segments can be serialized and packed into one or more data packets (e.g., by the SerDes 132). These data packets, along with the encrypted metadata, can be transmitted (e.g., by the transceiver 134) from the client to the server. After receiving the data (e.g., by the transceiver 152), the server extracts the image segments from the data packets (e.g., by the SerDes 154). The received metadata and extracted image segments can be provided to an application (e.g., 155) of the server, wherein the image segments can be decoded individually (e.g., by the decoder 158). The server also decrypts the metadata (e.g., by the decryptor 156) to retrieve the reordering pattern. The shuffling process effectively obfuscates the original image 600, as the transmitted image segments are arranged in the reordered sequence. Thus, an unauthorized user who obtains the image segments but without the metadata would not be able to reassemble the original image 600.

For example, FIG. 6D illustrates an attempt to reassemble the image without knowledge of the reordering pattern. In this case, the reconstructed image 610 is assembled using the reordered sequence instead of the original sequence. As shown, the image segments appear jumbled and fail to form a coherent image. In contrast, FIG. 6E shows a successfully reassembled image 620 by the server, which uses the reordering pattern to restore the image segments to their original sequence.

### Example Obfuscation and Reassembly of Non-Uniform Image Segments

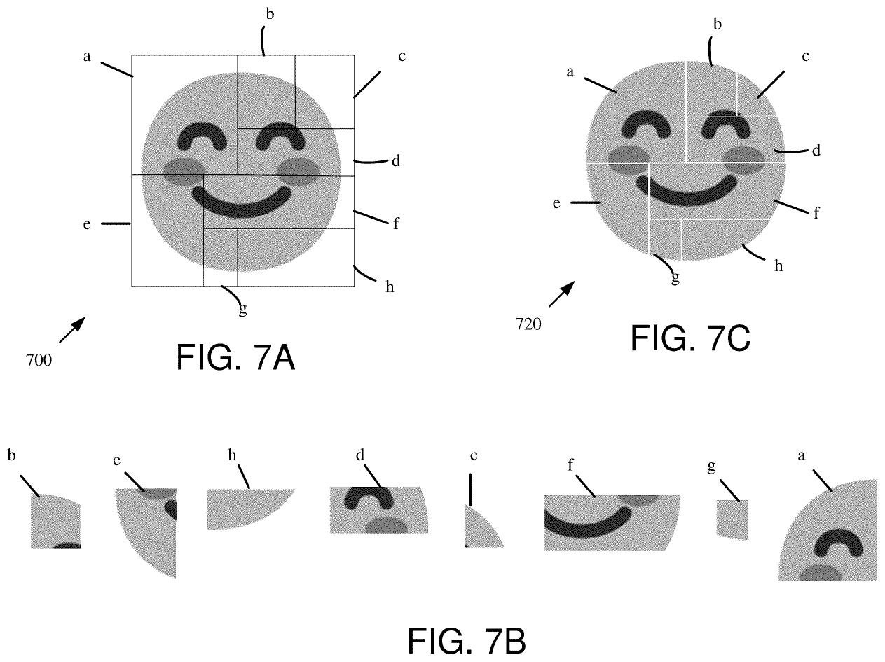

FIGS. 7A-7C illustrate another example use case of obfuscating and reassembling an image file using the techniques described herein.

FIG. 7A illustrates non-uniform segmentation of an original image 700, according to one example. As shown, the image 700 is divided into segments (labelled as a-h) of varying sizes and shapes, all rectangular in this example (but can be non-rectangular in other examples). The original sequence of the segments can be represented by a vector [a, b, c, d, e, f, g, h], wherein each element of the vector can include or be associated with positional information of a corresponding segment, such as the (x, y) coordinates of the top-left corner of the segment. In some examples, the coordinates of each segment can be used as the unique identifier of the segment.

FIG. 7B shows these non-uniform segments after they have been shuffled according to a reordering pattern, which can be represented by a vector [b, e, h, d, c, f, g, a] in this example. The image segments are encoded individually and transmitted in this reordered sequence, along with encrypted metadata containing a reordering pattern which maps the original sequence to the reordered sequence.

After receiving the transmitted data, the server decodes the image segments and decrypts the metadata to retrieve the reordering pattern, including the coordinates of each segment. FIG. 7C illustrates the reassembled image 720, where the segments are combined based on the reordering pattern, including the coordinates of each segment.

### Example Obfuscation and Reassembly of Multiple Images

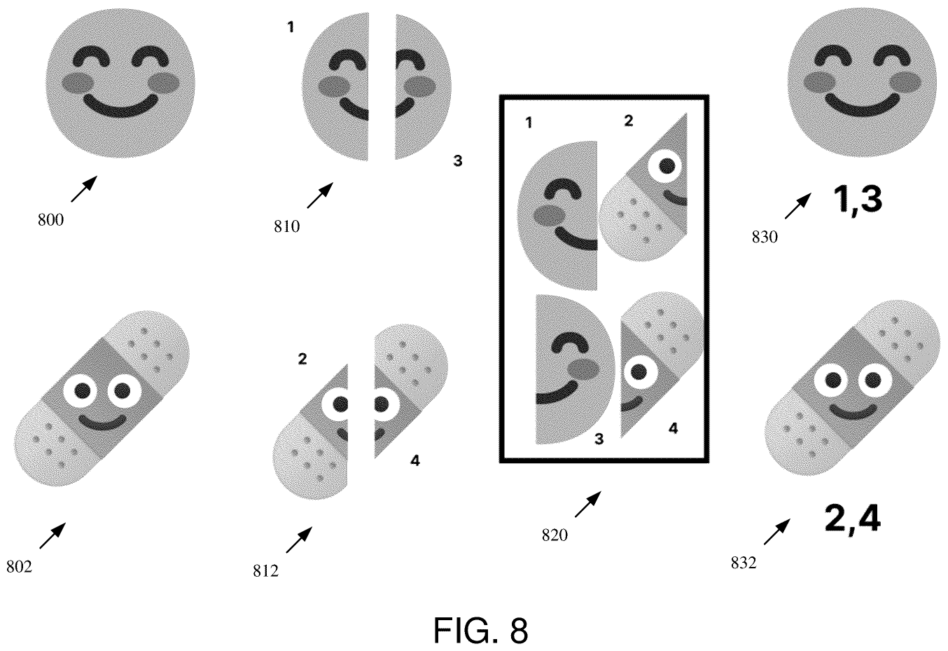

FIG. 8 schematically illustrates a process of obfuscating segments of two images and then reassembling the two images concurrently using segments of the two data images.

In this example, a first image 800 is divided into a first set of image segments 810 ordered in a first original sequence. Two segments, labelled 1 and 3 from left to right, are shown in this example for illustrative purposes, although it should be understood that the first image 800 can be divided into many more segments, either having a uniform size or multiple different sizes, as described above. Similarly, a second image 802 is divided into a second set of image segments 812 ordered in as second original sequence. Again, two segments, labelled 2 and 4 from left to right, are shown in this example, although it should be understood that the second image 802 can also be divided into many more uniform or non-uniform segments.

The segments of these two different images can be shuffled together, resulting in a combined set of image segments 820 ordered in a reordered sequence. A reordering pattern can map the first original sequence of the first set of image segments 810 (from image 800) and the second original sequence of the second set of image segments 812 (from image 802) to this reordered sequence. Each segment can be individually encoded, and metadata, including the reordering pattern, can be encrypted. The encoded image segments, now in their mixed reordered sequence, along with the encrypted metadata, can be transmitted from the client to the server.

Upon receiving the transmission, the server can decode the image segments and decrypt the metadata to retrieve the reordering pattern, allowing the server to reassemble both images (e.g., reconstructed first image 830 and reconstructed second image 832) concurrently based on the original sequences of their respective segments.

### Example Obfuscation and Reassembly of One-Dimensional Signal

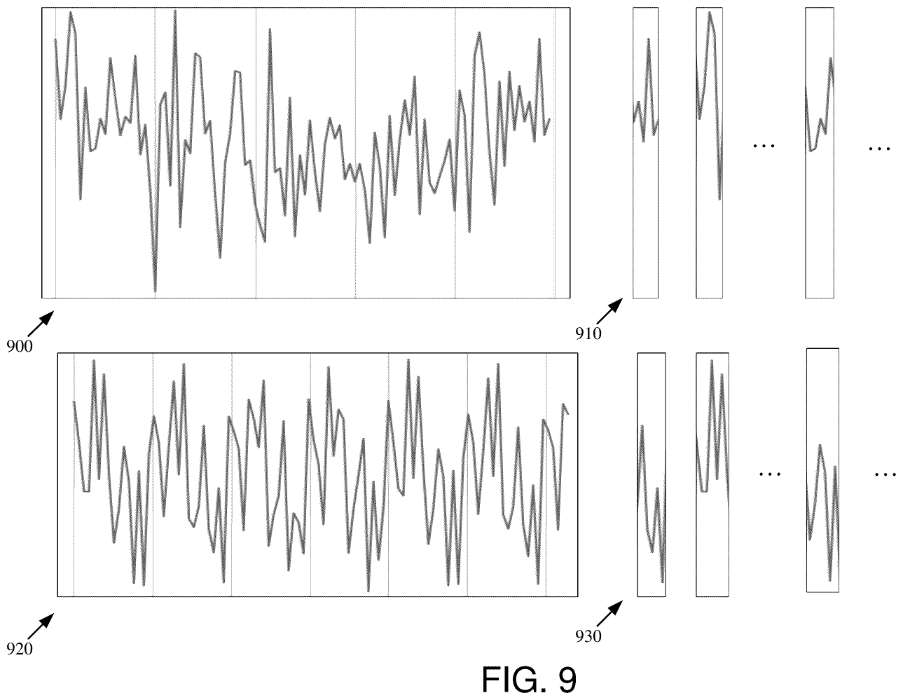

FIG. 9 illustrates segment-wise obfuscation and reconstruction of one-dimensional data files according to the disclosed technologies.

In this example, a data file 900 includes one-dimensional data. The horizontal axis can be time (e.g., if the data represents an audio signal), samples (e.g., if the data represents samples of a sensor output), or any other units (e.g., byte offset if the data represents a binary data file). The data file 900 can be divided into a set of data segments 910. Each segment can be assigned a unique identifier and encoded individually. These segments are then shuffled from their original sequence into a reordered sequence according to a reordering pattern. The reordering pattern, which maps the original sequence to the reordered sequence, can be included in the encrypted metadata. Both the reordered data segments and the encrypted metadata are transmitted from the client to the server. Upon receipt, the server can decode the data segments and decrypt the metadata to retrieve the reordering pattern. The server then uses this reordering pattern to combine or concatenate the data segments into their original order sequence, thereby reassembling the original data file 900.

In some examples, multiple data files can be obfuscated and reassembled together. For instance, another data file 920 can be similarly divided into a separate set of data segments 930. These segments, like those from the first data file, can be assigned unique identifiers and encoded. Both sets of data segments (910 from the first file and 930 from the second file) are then shuffled together to create a combined set of mixed data segments arranged in a reordered sequence. The reordering pattern, which maps the original sequences of both data files to the shuffled sequence, can be included in the encrypted metadata. The client can transmit this combined data, including the shuffled data segments and the encrypted metadata, to the server. Upon receipt, the server decrypts the metadata to retrieve the reordering pattern. Using this reordering pattern, the server can then reconstruct both the first data file 900 and the second data file 920 concurrently by correctly ordering and combining their respective data segments.

### Example Obfuscation and Reassembly of Text Data Files

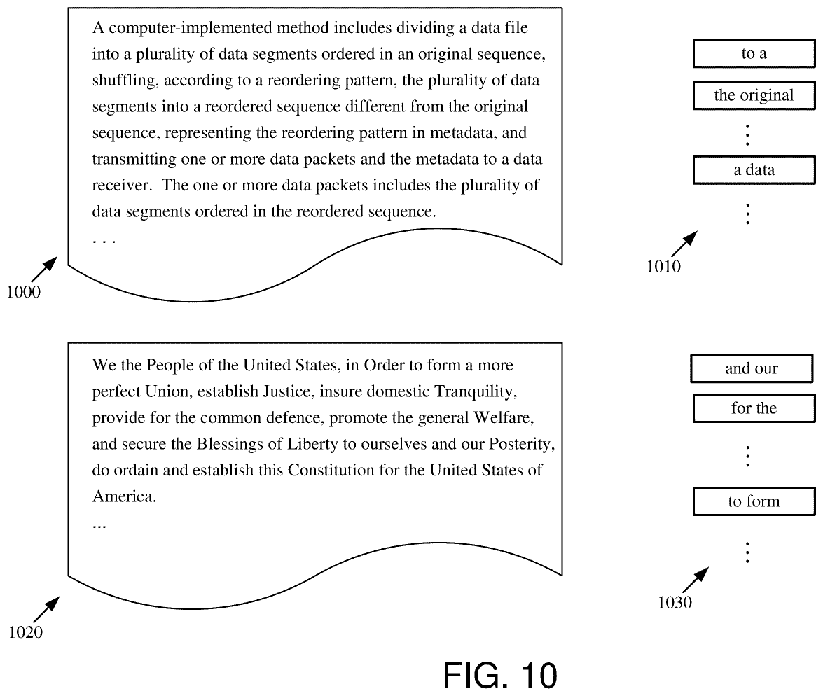

FIG. 10 illustrates segment-wise obfuscation and reconstruction of text documents (which can be considered as specific examples of one-dimensional data files) according to the disclosed technologies.

In this example, a text document 1000 is divided into a set of text segments 1010. The text segments can have uniform sizes or non-uniform sizes, depending on the segmentation criteria. For example, segmentation can be based on number of characters per segment, number of tokens (words) per segment, number of sentences per second, number of paragraphs per segment, or the like. In the depicted example, each segment contains two tokens merely for the purpose of illustration.

Once segmented, these text segments 1010 can be shuffled from their original sequence into a reordered sequence, following a specific reordering pattern. This reordering pattern, which maps the original sequence of the text segments to their reordered sequence, is included in encrypted metadata. Both the reordered text segments and the encrypted metadata are then transmitted to the server. Upon receipt, the server decrypts the metadata to retrieve the reordering pattern and uses it to combine the text segments in their original sequence, thereby reassembling the original text document 1000.

In some examples, multiple text documents can be obfuscated and reassembled together. For instance, another text document 1020 can be similarly divided into a separate set of text segments 1030. Both sets of text segments (text segments 1010 from the first text document 1000 and text segments 1030 from the second text document 1020) are shuffled together, resulting in a combined set of text segments arranged in a reordered sequence. The reordering pattern, which maps the original sequences of both text documents to the reordered sequence, can be included in the encrypted metadata. The mixed and shuffled text segments, along with the encrypted metadata, can be transmitted to the server. After receiving the data, the server decrypts the metadata, retrieves the reordering pattern, and uses it to reconstruct both the first text document 1000 and the second text document 1020 concurrently by reassembling their respective text segments into their original sequences.

### Example Obfuscation and Reassembly of Three-Dimensional Images

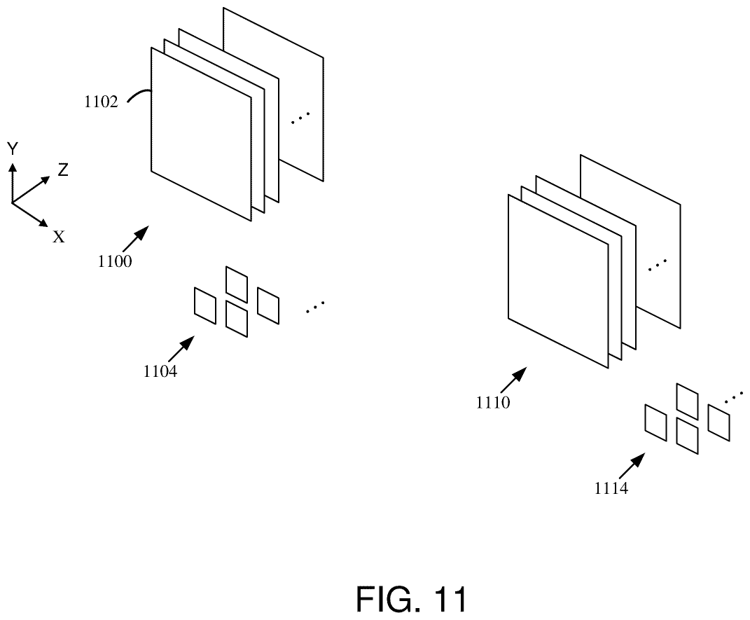

FIG. 11 illustrates segment-wise obfuscation and reconstruction of three-dimensional (3D) images according to the disclosed technologies.

In some examples, an image file can represent a 3D object. A 3D image file can be created by using a series of two-dimensional (2D) images taken from different angles around the object, which are then combined using software to create a 3D model of the object. The 3D image file can have different representations. As an example, FIG. 11 illustrates a 3D image file 1100 which can be represented by a number of two-dimensional (2D) image slices 1102, with each slice extending along one axis (e.g., along the Z-axis) and defining a plane (e.g., along X and Y axes). In some examples, different coordinate systems, such as polar coordinates, can be used instead of Cartesian coordinates to represent the 3D image file.

The 3D image file 1100 can be segmented into a plurality of image segments 1104. Various approaches can be used to segment a 3D image, depending on the desired granularity and the coordinate system used. For instance, the 3D image file can be divided along the X, Y, and Z dimensions. One example approach is to slice the 3D image along the Z-axis, yielding multiple 2D slices 1102 (as in FIG. 11) that represent cross-sections of the object. These 2D slices 1102 can then be further divided into smaller rectangular or non-rectangular image segments 1104 along the X and Y dimensions, resulting in smaller tiles. Alternatively, the image segments can be defined as tiles in the X-Z plane or the Y-Z plane, by slicing the object along Y-axis or X-axis, respectively. In still other examples, an image segment can be a small 3D cuboid that includes pixels along all three dimensions. In some cases, non-uniform segmentation can be applied, producing image segments of varying sizes and shapes.

Once segmented, these image segments 1104 can be shuffled into a reordered sequence according to a specific reordering pattern. As described above, this reordering pattern can be included metadata for encryption. A client can send the reordered image segments, along with the encrypted metadata, to a server. After receiving the scrambled data, the server decrypts the metadata to retrieve the reordering pattern, and uses it to reassemble the original 3D image file 1100 by combining the image segments 1104 back into their original sequence.

In some cases, multiple 3D image files can be obfuscated and reassembled together. For example, another 3D image file 1110 can be segmented into respective image segments 1114 in a similar manner. The image segments from both 3D image files (segments 1104 from image file 1100 and segments 1114 from image file 1110) can then be combined and shuffled together, resulting in a reordered sequence of mixed segments. The reordering pattern, which now maps the original segments from both images to the reordered sequence, can be stored in the encrypted metadata. The shuffled segments and the encrypted metadata are transmitted to the server, which decrypts the metadata to retrieve the reordering pattern. Using this information, the server can reassemble both 3D image files 1100 and 1100 concurrently by placing their respective image segments (1104 and 1114) back into their original sequences.

### Example Obfuscation and Reassembly of Video Signals

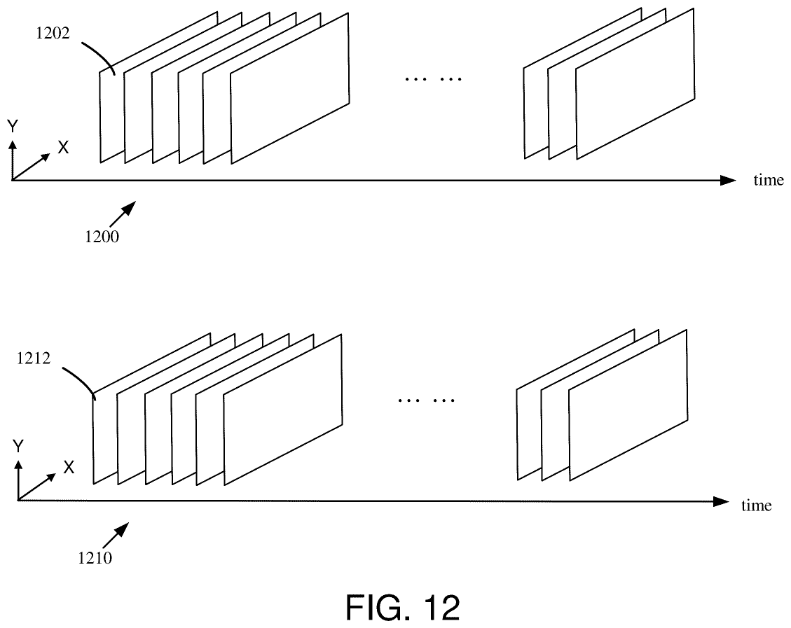

FIG. 12 illustrates segment-wise obfuscation and reconstruction of video signals according to the disclosed technologies.

A video signal typically includes a series of video frames, with each frame representing a 2D image. These frames, when displayed in sequence, create the perception of motion. The entire set of video frames within a video file can be stacked together and treated as if they form a 3D image, with time as an additional dimension. In this case, the X and Y dimensions can represent the spatial resolution of each frame, and the Z dimension can represent the progression of frames over time.

In FIG. 12, a video file 1200 includes a plurality of video frames 1202. Various methods can be employed to segment the video file 1200. One option is to segment along the time axis, treating each individual frame 1202 as a segment. This approach obfuscates the video by reordering the sequence of video frames 1202. Alternatively, each frame can be split into smaller segments or tiles along the X and Y dimensions, thereby segmenting the spatial information within each video frame. In another method, segmenting can occur along both the time axis and the spatial axis. For example, a segment could include pixels from several adjacent video frames where the pixels have the same X and Y coordinates. This approach preserves temporal continuity within small regions of the video. Additionally, segmentation can generate 3D segments, where each segment includes stacks of tiles from adjacent video frames, capturing both temporal and spatial information.

After the video file 1200 has been segmented, the individual segments can be shuffled into a reordered sequence according to a reordering pattern. This reordering pattern, which maps the original sequence of video segments to the reordered sequence, can be included in encrypted metadata. The reordered video segments and the encrypted metadata are transmitted from the client to the server. Upon receipt, the server decrypts the metadata to retrieve the reordering pattern and uses it to reassemble the video file 1200 by combining or concatenating the video segments back into their original sequence.

In some cases, multiple video files can be obfuscated and reassembled together. For instance, another video file 1210 can be similarly divided into segments, such as individual video frames 1212 (or other units). The video segments from both video files (e.g., video frames 1202 from video file 1200 and video frames 1212 from video file 1210) can be combined and shuffled together to form a reordered sequence. The reordering pattern, which maps the original sequences of both video files to the reordered sequence, can be included in the encrypted metadata. The mixed video segments and the encrypted metadata are then transmitted from the client to the server. Upon receipt, the server decrypts the metadata to retrieve the reordering pattern, which it uses to reassemble the original video files by combining or concatenating the shuffled segments back into their respective original sequences.

### Example Advantages

The disclosed technologies offer several technical advantages that enhance data security, integrity, and efficiency across various use cases involving file transmission, storage, and reconstruction.

One technical feature disclosed herein is the ability to divide a data file, or payload, into segments, shuffle these segments into a different sequence according to a reordering pattern, and represent the reordering pattern in metadata. The shuffled segments and the metadata can then be sent to a receiver, where both the shuffled segments and the metadata (or the reordering pattern) can be stored. This feature enhances security because the original structure of the data file is obscured by the shuffled segments, making it difficult for unauthorized parties to reconstruct the original file without the metadata. This adds an extra application layer of protection for sensitive data during transmission, in addition to any network-level security measures (which generally focus on encrypting or securing the communication channel itself).

Another important advantage is the use of metadata to store the reordering pattern, which can map the scrambled segments back to their original positions. This enables precise and efficient reconstruction of the original data files by using the metadata to guide the arrangement of segments in the correct order.

Additionally, the disclosed technologies provide efficient storage management capabilities. Data segments and the corresponding metadata containing the reordering pattern can be stored, allowing for the reconstruction of the file when needed. Deleting the file is as simple as removing the metadata, which makes the stored segments unusable without the reordering information.

Further, the disclosed obfuscation and reassembly techniques are versatile and can be applied to various file types, including images, text documents, videos, and more. This flexibility makes the approach adaptable across different content types, allowing users to enhance security for a wide range of data without requiring different systems for each file format.

Moreover, the disclosed technologies allow for the concurrent obfuscation and reassembly of multiple files. By segmenting and shuffling these files together, it becomes significantly more challenging to decipher the original content of any individual file without the necessary metadata. For example, interleaving or mixed segments from different data sources adds an additional layer of complexity, as an unauthorized party would not only need to unscramble the segments but also correctly separate and reassemble them based on their respective sources.

### Example Computing Systems

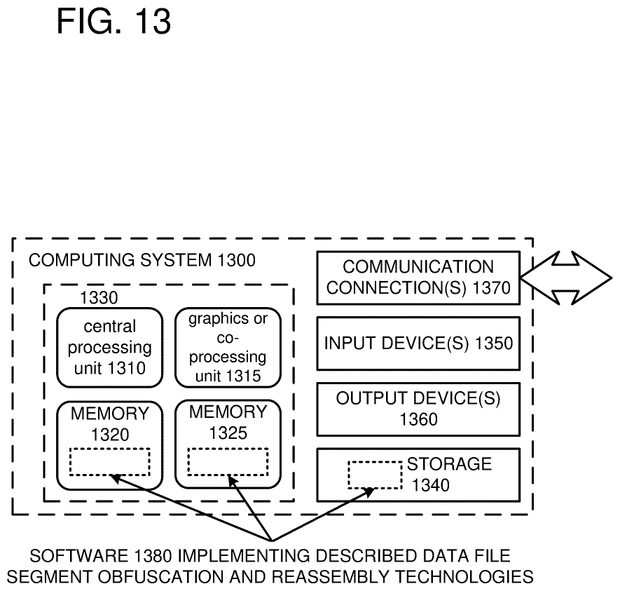

FIG. 13 depicts an example of a suitable computing system 1300 in which the described innovations can be implemented. The computing system 1300 is not intended to suggest any limitation as to scope of use or functionality of the present disclosure, as the innovations can be implemented in diverse computing systems.

With reference to FIG. 13, the computing system 1300 includes one or more processing units 1310, 1315 and memory 1320, 1325. In FIG. 13, this basic configuration 1330 is included within a dashed line. The processing units 1310, 1315 can execute computer-executable instructions, such as for implementing the features described in the examples herein (e.g., the methods 200, 300, 400, 500). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 13 shows a central processing unit 1310 as well as a graphics processing unit or co-processing unit 1315. The tangible memory 1320, 1325 can be volatile memory (e.g., registers, cache, RAM), non-volatile memory (e.g., ROM, EEPROM, flash memory, etc.), or some combination of the two, accessible by the processing unit(s) 1310, 1315. The memory 1320, 1325 can store software 1380 implementing one or more innovations described herein, in the form of computer-executable instructions suitable for execution by the processing unit(s) 1310, 1315.

More generally, the term “processor” refers generically to any device that can process computer-executable instructions and may include a microprocessor, microcontroller, programmable logic device, digital signal processor, and/or other computational device. A processor may be a processing core of a CPU, other general-purpose unit, or GPU. A processor may also be a specific-purpose processor implemented using, for example, an ASIC or a field-programmable gate array (“FPGA”). A “processor system” is a set of one or more processors, which can be located together or distributed across a network.

A computing system 1300 can have additional features. For example, the computing system 1300 can include storage 1340, one or more input devices 1350, one or more output devices 1360, and one or more communication connections 1370, including input devices, output devices, and communication connections for interacting with a user. An interconnection mechanism (not shown) such as a bus, controller, or network can interconnect the components of the computing system 1300. Typically, operating system software (not shown) can provide an operating environment for other software executing in the computing system 1300, and coordinate activities of the components of the computing system 1300.

The tangible storage 1340 can be removable or non-removable, and includes magnetic disks, magnetic tapes or cassettes, CD-ROMs, DVDs, or any other medium which can be used to store information in a non-transitory way and which can be accessed within the computing system 1300. The storage 1340 can store instructions for the software implementing one or more innovations described herein.

The input device(s) 1350 can be an input device such as a keyboard, mouse, pen, or trackball, a voice input device, a scanning device, touch device (e.g., touchpad, display, or the like) or another device that provides input to the computing system 1300. The output device(s) 1360 can be a display, printer, speaker, CD-writer, or another device that provides output from the computing system 1300.

The communication connection(s) 1370 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Computer-readable media can have stored thereon data segments and metadata that have been produced as described herein and/or are organized for reconstruction operations as described herein. For example, computer-readable media have stored thereon a plurality of data segments, for a data file, ordered in a reordered sequence as well as metadata that represents a reordering pattern, as described herein. The plurality of data segments can be included in one or more data packets. The plurality of data segments and metadata can result from operations comprising dividing the data file into the plurality of data segments ordered in an original sequence, shuffling, according to the reordering pattern, the plurality of data segments into the reordered sequence (different from the original sequence), and representing the reordering pattern in the metadata. The plurality of data segments and metadata can be organized to facilitate reconstruction by operations comprising retrieving the plurality of data segments ordered in the reordered sequence, retrieving the metadata indicating the reordering pattern, and constructing the data file using the plurality of data segments (including combining, according to the reordering pattern, the plurality of data segments into the original sequence). A cloud-based data repository can be configured to receive data segments and metadata, then store the data segments and metadata on computer-readable media. A cloud-based data repository can also be configured to retrieve data segments and metadata that have been stored on computer-readable media, then transmit the data segments and metadata to one or more data receivers.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

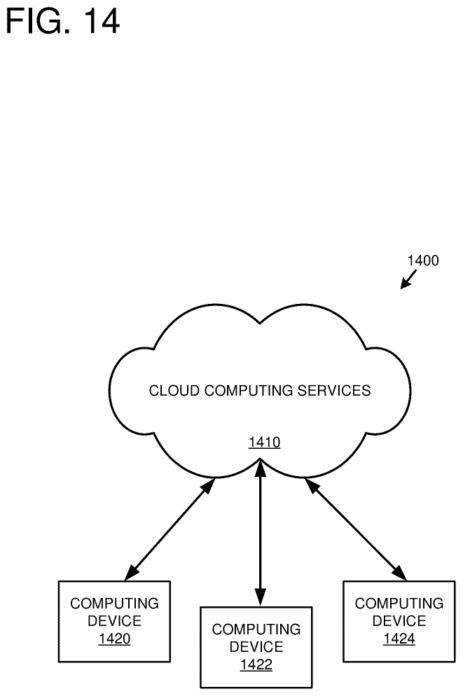

FIG. 14 depicts an example cloud computing environment 1400 in which the described technologies can be implemented, including, e.g., the system 100 and other systems herein. The cloud computing environment 1400 can include cloud computing services 1410. The cloud computing services 1410 can comprise various types of cloud computing resources, such as computer servers, data storage repositories, networking resources, etc. The cloud computing services 1410 can be centrally located (e.g., provided by a facility of a business or organization) or distributed (e.g., provided by various computing resources located at different locations, such as different facilities and/or located in different cities or countries).

The cloud computing services 1410 can be utilized by various types of computing devices (e.g., client computing devices), such as computing devices 1420, 1422, and 1424. For example, the computing devices (e.g., 1420, 1422, and 1424) can be computers (e.g., desktop or laptop computers), mobile devices (e.g., tablet computers or smart phones), or other types of computing devices. For example, the computing devices (e.g., 1420, 1422, and 1424) can utilize the cloud computing services 1410 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

In any of the examples described herein, an operation performed in runtime means that the operation can be completed in real time or with negligible processing latency (e.g., the operation can be completed within 1 second, etc.).

### EXAMPLE CLAUSES

Any of the following example clauses can be implemented.

### Clause 1

A computer-implemented method, comprising, with a software application: dividing a data file into a plurality of data segments; assigning segment identifiers to the data segments, respectively, wherein the data segments, if combined using a first sequence of the segment identifiers, form the data file; shuffling, according to a reordering pattern, the segment identifiers into a second sequence of the segment identifiers, the second sequence being different from the first sequence, wherein the reordering pattern indicates a mapping between the first sequence and the second sequence; representing the reordering pattern in metadata; and providing, to an interface for an implementation of one or more networking protocols, the plurality of data segments and the metadata, wherein the implementation of one or more networking protocols implements at least a transport protocol, and wherein the plurality of data segments are provided to the interface in order of the second sequence.

### Clause 2

The method of clause 1, wherein the data file is an image file, a video file, an audio file, or a text document.

### Clause 3

The method of any one of clauses 1-2, wherein the plurality of data segments have a uniform size or have multiple non-uniform sizes.

### Clause 4

The method of any one of clauses 1-3, further comprising, with the implementation of one or more networking protocols: packetizing the plurality of data segments and the metadata into plural packets; transmitting the plural packets to a data receiver, the data receiver being configured to: receive the plural packets; recover the plurality of data segments and the metadata from the plural packets; retrieve the metadata; retrieve the plurality of data segments in order of the second sequence; and save the data file by storing the plurality of data segments as individual files in a cloud-based data repository and recording the metadata in a file log of the cloud-based data repository.

### Clause 5

The method of any one of clauses 1-4, wherein the metadata comprises a series of the segment identifiers for the plurality of data segments, respectively, in the second sequence.

### Clause 6

The method of any one of clauses 1-5, wherein the segment identifiers are numerical values, alphabetical values, string values, or coordinate values.

### Clause 7

The method of any one of clauses 1-6, wherein the metadata comprises a seed value, the seed value being usable by a random number generator to generate the second sequence.

### Clause 8

The method of any one of clauses 1-7, wherein representing the reordering pattern in metadata comprises encrypting the reordering pattern using a public key of a data receiver, the method further comprising, with the implementation of one or more networking protocols: packetizing the plurality of data segments and the metadata into plural packets; transmitting the plural packets to the data receiver, the data receiver being configured to: receive the plural packets; recover the plurality of data segments and the metadata from the plural packets; retrieve the metadata; retrieve the plurality of data segments in order of the second sequence; decrypt the reordering pattern from the metadata; and construct the data file using the plurality and the reordering pattern.

### Clause 9

The method of any one of clauses 1-8, further comprising, with the software application: encoding the plurality of data segments individually.

### Clause 10

The method of any one of clauses 1-9, wherein the second sequence represents a random permutation of the first sequence.

### Clause 11

One or more computer-readable media having stored thereon computer-executable instructions for causing a computer system, when programmed thereby, to perform operations comprising, with a software application: retrieving, from an interface for an implementation of one or more networking protocols, metadata relating to a plurality of data segments having segment identifiers, respectively, wherein the implementation of one or more networking protocols implements at least a transport protocol, and wherein the metadata represents a reordering pattern that indicates a mapping between a first sequence of the segment identifiers and a second sequence of the segment identifiers, the second sequence being different from the first sequence; retrieving, from the interface for the implementation of one or more networking protocols, the plurality of data segments in order of the second sequence; and constructing a data file using the plurality of data segments and the reordering pattern, including combining, using the first sequence according to the reordering pattern, the plurality of data segments into the data file.

### Clause 12

The one or more computer-readable media of clause 11, the operations further comprising, with the software application: decoding the plurality of data segments individually.

### Clause 13

The one or more computer-readable media of any one of clauses 11-12, the operations further comprising, with the software application: decrypting the metadata using a private key, wherein the decrypting generates the reordering pattern.

### Clause 14

The one or more computer-readable media of any one of clauses 11-13, the operations further comprising, with the software application: saving the data file in a cloud-based data repository, wherein the saving comprises storing the plurality of data segments as individual files in the cloud-based data repository and recording the metadata in a file log of the cloud-based data repository.

### Clause 15

The one or more computer-readable media of clause 14, the operations further comprising, with the software application: deleting the data file from the cloud-based data repository, wherein the deleting comprises removing the metadata from the file log of the cloud-based data repository.

### Clause 16

The one or more computer-readable media of any one of clauses 11-15, wherein the data file is an image file, a video file, an audio file, or a text document.

### Clause 17

The one or more computer-readable media of any one of clauses 11-16, wherein the plurality of data segments have a uniform size or have multiple non-uniform sizes.

### Clause 18

The one or more computer-readable media of any one of clauses 11-17, the operations further comprising, with the interface for the implementation of one or more networking protocols: receiving plural packets; and recovering the plurality of data segments and the metadata from the plural packets.

### Clause 19

A computer system comprising one or more processing units and memory, wherein the computer system is configured to perform operations comprising, with a software application: dividing a first data file into a plurality of first data segments; assigning first segment identifiers to the first data segments, respectively, wherein the first data segments, if combined using a first sequence of the first segment identifiers, form the first data file; dividing a second data file into a plurality of second data segments; assigning second segment identifiers to the second data segments, respectively, wherein the second data segments, if combined using a second sequence of the second segment identifiers, form the second data file; shuffling, according to a reordering pattern, the first segment identifiers and the second segment identifiers into a reordered sequence of the first segment identifiers and the second segment identifiers, wherein the reordering pattern indicates a mapping from the first and second sequences to the reordered sequence and vice versa; representing the reordering pattern in metadata; and providing, to an interface for an implementation of one or more networking protocols, the plurality of first data segments, the plurality of second data segments, and the metadata, wherein the implementation of one or more networking protocols implements at least a transport protocol, and wherein the plurality of first data segments and the plurality of second data segments are provided to the interface in order of the reordered sequence.

### Clause 20

The computer system of clause 19, the operations further comprising, with the implementation of one or more networking protocols: packetizing the plurality of first data segments, the plurality of second data segments, and the metadata into plural packets; transmitting the plural packets to a data receiver, the data receiver being configured to: receive the plural packets; recover the plurality of first data segments, the plurality of second data segments, and the metadata from the plural packets; retrieve the metadata; retrieve the plurality of first data segments and the plurality of second data segments in order of the reordered sequence; construct the first data file using the plurality of first data segments and the reordering pattern, including combining, using the first sequence according to the reordering pattern, the plurality of first data segments into the first data file; and construct the second data file using the plurality of second data segments and the reordering pattern, including combining, using the second sequence according to the reordering pattern, the plurality of second data segments into the second data file.

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method, comprising, with a software application:
dividing a data file into a plurality of data segments;
assigning segment identifiers to the data segments, respectively, wherein the data segments, if combined using a first sequence of the segment identifiers, form the data file;
shuffling, according to a reordering pattern, the segment identifiers into a second sequence of the segment identifiers, the second sequence being different from the first sequence, wherein the reordering pattern indicates a mapping between the first sequence and the second sequence;
representing the reordering pattern in metadata; and
providing, to an interface for an implementation of one or more networking protocols, the plurality of data segments and the metadata, wherein the implementation of one or more networking protocols implements at least a transport protocol, and wherein the plurality of data segments are provided to the interface in order of the second sequence.

2. The method of claim 1, wherein the data file is an image file, a video file, an audio file, or a text document.

3. The method of claim 1, wherein the plurality of data segments have a uniform size or have multiple non-uniform sizes.

4. The method of claim 1, further comprising, with the implementation of one or more networking protocols:
packetizing the plurality of data segments and the metadata into plural packets;
transmitting the plural packets to a data receiver, the data receiver being configured to:
receive the plural packets;
recover the plurality of data segments and the metadata from the plural packets;
retrieve the metadata;
retrieve the plurality of data segments in order of the second sequence; and
save the data file by storing the plurality of data segments as individual files in a cloud-based data repository and recording the metadata in a file log of the cloud-based data repository.

5. The method of claim 1, wherein the metadata comprises a series of the segment identifiers for the plurality of data segments, respectively, in the second sequence.

6. The method of claim 1, wherein the segment identifiers are numerical values, alphabetical values, string values, or coordinate values.

7. The method of claim 1, wherein the metadata comprises a seed value, the seed value being usable by a random number generator to generate the second sequence.

8. The method of claim 1, wherein representing the reordering pattern in metadata comprises encrypting the reordering pattern using a public key of a data receiver, the method further comprising, with the implementation of one or more networking protocols:
packetizing the plurality of data segments and the metadata into plural packets;
transmitting the plural packets to the data receiver, the data receiver being configured to:
receive the plural packets;
recover the plurality of data segments and the metadata from the plural packets;
retrieve the metadata;
retrieve the plurality of data segments in order of the second sequence;
decrypt the reordering pattern from the metadata; and
construct the data file using the plurality and the reordering pattern.

9. The method of claim 1, further comprising, with the software application:
encoding the plurality of data segments individually.

10. The method of claim 1, wherein the second sequence represents a random permutation of the first sequence.

11. One or more computer-readable media having stored thereon computer-executable instructions for causing a computer system, when programmed thereby, to perform operations comprising, with a software application:
retrieving, from an interface for an implementation of one or more networking protocols, metadata relating to a plurality of data segments having segment identifiers, respectively, wherein the implementation of one or more networking protocols implements at least a transport protocol, and wherein the metadata represents a reordering pattern that indicates a mapping between a first sequence of the segment identifiers and a second sequence of the segment identifiers, the second sequence being different from the first sequence;
retrieving, from the interface for the implementation of one or more networking protocols, the plurality of data segments in order of the second sequence; and
constructing a data file using the plurality of data segments and the reordering pattern, including combining, using the first sequence according to the reordering pattern, the plurality of data segments into the data file.

12. The one or more computer-readable media of claim 11, the operations further comprising, with the software application:
decoding the plurality of data segments individually.

13. The one or more computer-readable media of claim 11, the operations further comprising, with the software application:
decrypting the metadata using a private key, wherein the decrypting generates the reordering pattern.

14. The one or more computer-readable media of claim 11, the operations further comprising, with the software application:
saving the data file in a cloud-based data repository, wherein the saving comprises storing the plurality of data segments as individual files in the cloud-based data repository and recording the metadata in a file log of the cloud-based data repository.

15. The one or more computer-readable media of claim 14, the operations further comprising, with the software application:
deleting the data file from the cloud-based data repository, wherein the deleting comprises removing the metadata from the file log of the cloud-based data repository.

16. The one or more computer-readable media of claim 11, wherein the data file is an image file, a video file, an audio file, or a text document.

17. The one or more computer-readable media of claim 11, wherein the plurality of data segments have a uniform size or have multiple non-uniform sizes.

18. The one or more computer-readable media of claim 11, the operations further comprising, with the interface for the implementation of one or more networking protocols:
receiving plural packets; and
recovering the plurality of data segments and the metadata from the plural packets.

19. A computer system comprising one or more processing units and memory, wherein the computer system is configured to perform operations comprising, with a software application:
dividing a first data file into a plurality of first data segments;
assigning first segment identifiers to the first data segments, respectively, wherein the first data segments, if combined using a first sequence of the first segment identifiers, form the first data file;
dividing a second data file into a plurality of second data segments;
assigning second segment identifiers to the second data segments, respectively, wherein the second data segments, if combined using a second sequence of the second segment identifiers, form the second data file;
shuffling, according to a reordering pattern, the first segment identifiers and the second segment identifiers into a reordered sequence of the first segment identifiers and the second segment identifiers, wherein the reordering pattern indicates a mapping from the first and second sequences to the reordered sequence and vice versa;
representing the reordering pattern in metadata; and
providing, to an interface for an implementation of one or more networking protocols, the plurality of first data segments, the plurality of second data segments, and the metadata, wherein the implementation of one or more networking protocols implements at least a transport protocol, and wherein the plurality of first data segments and the plurality of second data segments are provided to the interface in order of the reordered sequence.

20. The computer system of claim 19, the operations further comprising, with the implementation of one or more networking protocols:
packetizing the plurality of first data segments, the plurality of second data segments, and the metadata into plural packets;
transmitting the plural packets to a data receiver, the data receiver being configured to:
receive the plural packets;
recover the plurality of first data segments, the plurality of second data segments, and the metadata from the plural packets;
retrieve the metadata;
retrieve the plurality of first data segments and the plurality of second data segments in order of the reordered sequence;
construct the first data file using the plurality of first data segments and the reordering pattern, including combining, using the first sequence according to the reordering pattern, the plurality of first data segments into the first data file; and
construct the second data file using the plurality of second data segments and the reordering pattern, including combining, using the second sequence according to the reordering pattern, the plurality of second data segments into the second data file.
